(19) United States
(12) Patent Application Publication
(10) Pub. No.: US 2009/0106397 A1
(43) Pub. Date: Apr. 23, 2009

(54) Method and apparatus for interactive content distribution

(76) Inventor: Sean Patrick O'Keefe, San Diego, CA (US)

Correspondence Address: Sean Partrick O'Keefe, 812 Corral Ct, Bonita, CA, 91902, US

(21) Appl. No.: 12/231,649

(22) Filed: Sep. 4, 2008

Related U.S. Application Data
(60) Provisional application No. 60/970,237, filed on Sep. 5, 2007.

(51) Int. Cl. G06F 15/16

(52) U.S. Cl. 709/219

(57) ABSTRACT

Systems, methods, and apparatus for distributing content include receiving content from a content provider. Activating a media device when desired content is being observed. Building a request for the desired content, the request including information identifying the content provider. Communicating the request for the desired content to a media server that extracts the information identifying the content provider, the media server searches a network for the content provider and based identifies the content that the content provider was providing when the request was made. Retrieving the desired content, and providing the desired content to a requesting user.

### RELATED APPLICATIONS

This application claims the benefit of U.S. provisional patent application Ser. No. 60/970,237, filed Sep. 5, 2007, entitled “Method and Apparatus for Interactive Multimedia Distribution” which is hereby incorporated by reference in its entirety.

### BACKGROUND

1. Field of the Invention

This invention relates to content distribution, and in particular, to distribution of electronic content.

2. Background

Interactive Direct Response Marketing and Broad Based Electronic Distribution of multimedia content is becoming ubiquitous owing in large part to the advent and proliferation of the Internet. One example of this new electronic distribution is the ability to purchase electronic content such as videos and songs over the Internet and share and play them. For example, songs can be purchased and downloaded from various websites and played on any number of MP3 players as well as other devices like smart phones and PDA's using the MP3 music file format. This new type of electronic distribution has had a major impact on the industry such as the movie and music industry.

For example, the music industry is evolving to this new landscape, where records (vinyl) gave way to tapes and CD's, which are now giving way to digital formats. In this evolution the music industry has faced many challenges. For example, music is now sold and traded on the Internet and record stores have all but disappeared. With the disappearance of music stores, the music industry's interface to customers is changing.

As customers are increasingly relying on the Internet for their music purchases there will be fewer and fewer music stores. But some customer's may not always have Internet access. For example, if a customer is traveling, or if they are outside, such as at a park or the beach, they may not have access to the Internet and no longer have the ability to purchase music. Even customers that do have access to the Internet still need to know the name of the song or at least the artist to be able to search for the song. So if a customer is driving in their car and they hear a song that they would like to purchase the customer needs to hear and remember the song tile, or artist, until they get home so that they can search for the song online. This can be inconvenient because, for example, if the customer has never heard the song they will likely not remember the song tile that is usually given, if at all, before the song is played. After the song is over the customer knows they like the song but they do not know the song title or artist to search for the song when they return home and have Internet access.

While the above examples are directed to purchasing music on the Internet, similar problem exist for other forms of content and over other communication medias or channels. Thus, there is a need for improved techniques for interactive distribution of electronic content.

### SUMMARY

Systems, methods, and apparatus for distributing content are described. In one embodiment, a method of distributing content includes receiving content from a content provider. Activating a media device when desired content is being observed. Assembling a request for the desired content, the request including information identifying the content provider. In one embodiment, the request can also include a time the request was made. Communicating the request for the desired content to a media server that extracts the information identifying the content provider. The media server also determines a time the request was made, for example, if the time was included in the request the media server can use that time or the media server can determine the time of the request, for example when the request was received. The media server searches a network for the content provider and based on the time of the request identifies the content that the content provider was providing when the request was made. The media server retrieves the desired content, and provides the desired content to the requesting user.

In another embodiment, searching a network for the content provider includes searching the Internet for the content provider's website, or searching the Internet for the content provider's streaming data. In one embodiment, communicating the request includes communicating over a wireless communication channel, or a wired communication channel, or a combination of wireless and wired communication channels. Examples of providing the desired content to the requesting user include emailing the desired content to the requesting user, downloading the desired content to the requesting use, pushing the desired content to the requesting user, or other ways of delivering electronic content. The desired content can include, for example, an audio file, a video file, an advertisement, a multimedia file, or other type of content. Examples of retrieving the desired content includes retrieving the desired content from a database, from the content provider's website, from a third party website, or other location.

In another embodiment, a method of requesting content includes observing content provided by a content provider. Providing an indication that currently observed content is desired content. Providing a request for the desired content, the request including information identifying the content provider. In one embodiment, the request can also include a time the request was made. Communicating the request for the desired content to a media server. In one embodiment, the method also includes receiving the desired content from the media server.

In another embodiment, the request can include a geographic location of a user observing the content. Examples of the information identifying the content provider can include identifying a type of media that is being observed, identifying the station of the content provider, or other information.

In yet another embodiment, a method of distributing content includes receiving a request for desired content from a requesting user, the request includes information identifying a content provider. In one embodiment, the request can also include a time the request was made. Extracting the information identifying the content provider and determining the time the request was made. For example, the time can be included in the request or the time can be determined when the request is received Searching a network for the content provider and based on the time of the request identifying the content that the content provider was providing when the request was made. Retrieving the desired content, and providing the desired content to the requesting user.

Examples of providing the desired content to the requesting user include emailing the desired content to the requesting user, downloading the desired content to the requesting user, pushing the desired content to the requesting user, or other ways of delivering electronic content. In an embodiment, the request can includes a geographic location. Examples of searching the network for the content provider includes searching the Internet for a content provider's website, or the content provider's streaming media. In an embodiment, retrieving the desired content includes retrieving the content from the content provider's website, or retrieving the desired content from a third party website.

In still another embodiment, a media device includes a user interface for entering an indication that currently observed content is desired content. The media device also includes a processor that receives the indication and assemblies a request for the desired content, the request including information identifying the content provider. In one embodiment, the request includes a time the request was made. There is also a communication interface that receives the request from the processor and transmits the request for the desired content to a media server.

In another embodiment, a media server includes a network interface that receives a request for desired content from a requesting user, the request comprises information identifying a content provider. The media server also includes a processor that examines the received request and extracts the information identifying the content provider and determines a time the request was made. The processor initiates a search of a network for the content provider, and based on the time of the request, identifies the content that the content provider was providing when the request was made. The processor then retrieves the desired content and provides the desired content to the network interface that transmits the desired content to the requesting user.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a block diagram of an example embodiment of an interactive content distribution system.

FIG. 2 is a block diagram of an example embodiment of a media device that can gather information to be sent in a media request.

FIG. 3 is a block diagram of another example embodiment of a media device that can gather information to be sent in a media request.

FIG. 4 is a block diagram illustrating a content device that includes functions of a media device.

FIG. 5 is a flow chart illustrating an example embodiment of requesting content.

FIG. 6 is a flow chart illustrating an example embodiment of receiving a request for content and delivering the content to a user.

FIGS. 7A and 7B are a flow diagram illustrating another example embodiment of an integrated media electronic distribution and commerce system.

FIG. 8 is a block diagram of an example embodiment of an interactive content distribution system.

FIG. 9 is a block diagram of an example embodiment of a media device.

FIG. 10 is a block diagram of an example embodiment of a media server.

### DESCRIPTION

After reading the following description it would become apparent to one skilled in the art how to implement the invention in various alternative embodiments and alternative applications. However, although various embodiments of the present invention will be described herein, it is to be understood that these embodiments are presented by way of example only, and not limitations. As such, this detailed description of various embodiments should not be construed to limit the scope or breadth of the present invention.

Embodiments, described include an interactive distribution and commerce system for electronic media and content. The system can be used for many applications, for example, direct response advertising, music purchasing, game/quiz show participation, lotteries, find raising, polls, and other user or consumer activities in response to various electronic media Examples of the types of electronic media that a user can interact with through the system include radio, satellite radio, broadcast television, cable television, satellite television, wireless networks, such as the Internet, and other types of electronic media.

In one embodiment, the system can be used by a user, or consumer, to purchase electronic media. For example, the user can be listening to a radio station being broadcast through the air, or streaming online, and when the user hears a song that they like they indicate their desire to purchase the song. In this way, the system supports impulse purchases by the user, for example, while the user is listening to a song on the radio or watching a video on television, the user can indicate that they want to purchase the song or video. Information about the content provider the user is listening to, or observing, is collected and sent as part of a request to a server that uses the information to identify the content. For example, the information about the content provider can be used to search the Internet for the content provider's website, or for the content provider's streaming data. Additional information in the request, such as the time of the request can be used to determine the content that was being provided by the content provider when the request was made. The server can then search for the content, for example, from on the content provider's website, a third party website, a database, or other location. Then the server can provide the content to the user.

In another embodiment, the system allows a user, or consumer, to get additional information about an advertisement, such as an advertisement heard on the radio or seen on television, instantly on demand. For example, a consumer that is watching broadcast television may see an advertisement for a product that they would like additional information about. The user can indicate that they are interested in the advertised product. When the user makes the indication, information about the content provider that is being observed by the user is collected and sent as part of a request to a server. The server can then use the information to identify the content, or advertisement, that the user is interested in. For example, the information can include information, such as, that the user is watching broadcast television channel 8 in San Diego Calif. The server can use this information to determine that the user is watching the San Diego affiliate of CBS. The server can then search the Internet to find the content that the San Diego affiliate of CBS is providing. For example, the server can search for the website, or live stream, of the CBS affiliate in San Diego and determine what product is being advertised when the request was made. The server can then collect additional information about the product, such as from the CBS affiliate website, the product manufacture's website, a third party website, a local database, or other information source, and forward that information to the user.

Examples of the types of request can include purchasing music, making an advertising inquiry, participating in a game/quiz show, giving to a fund raising drive, participating in a poll, or other types of activities.

The system does not rely on additional, separate, or special, data to be included in the content. For example, there does not need to be additional data, or an additional channel, added to a signal broadcast by a content provider, such as a radio station, satellite radio, television broadcast, or other broadcast signal. The system relies upon information about the source of the content the user is observing to identify the content. For example, information identifying the source of the content being observed, the time the request was made, and other information can be sent from the user to a server. The server can then use this information to identify the content the user was observing. In one embodiment, the server can logon to the content provider's website and identify the content, or the server can logon to the content provider's live stream to identify the content, or logon to a third party website, such as a media guide site, or other website that provides information identifying content that is being provided by content providers. After identifying the content, the server can acquire the content, such as purchasing the identified content from a website, or other source, and provide the content to the user.

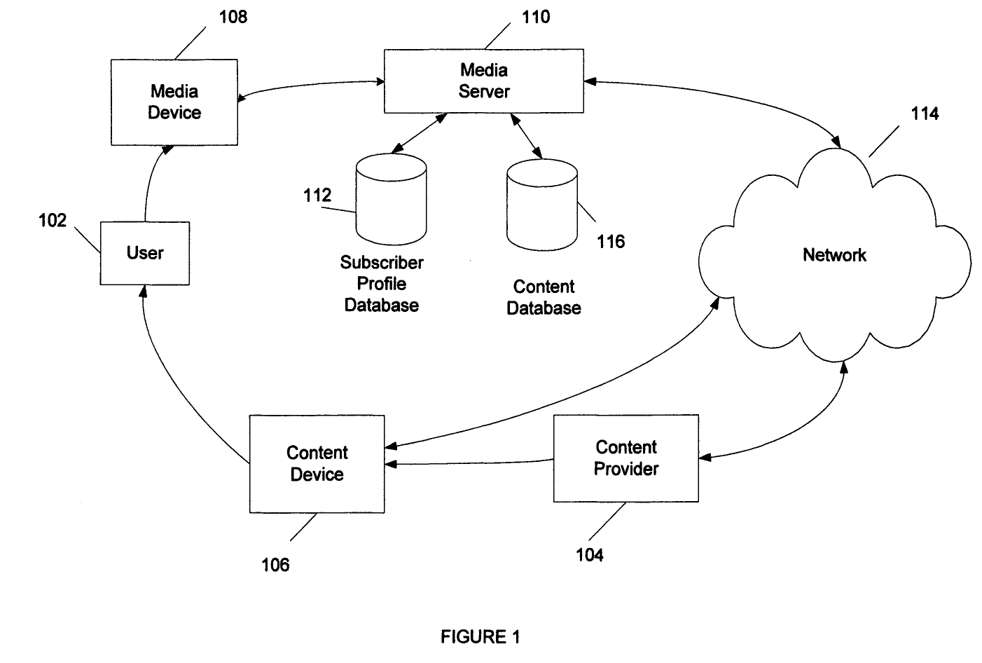

FIG. 1 is a block diagram of an example embodiment of an interactive content distribution system. As shown in FIG. 1, a user 102 receives content from a content provider 104 and observes the content on a content device 106. The content device 106 can be, for example, an MP3 player, a media player, a smart phone, a PDA, a television, a radio, such as a satellite radio or a car radio, a computer, or other type of device that can receive content through the air, cable, from a satellite, on the Internet, or other communication medium. The content device 106 can be a wired device or a wireless device. The content device 106 can receive content either through a wired connection, or a wireless connection or a combination of wireless and wired communications. For example, the content provider 104 transmit their contact over various types of communication channels, such as, a broadcast or satellite radio or television, a cable network, a wide area network, such as the Internet, or other communication channel for the delivery of content. In one embodiment, the content device 106 can connect to a network, such as the Internet, and receive content such as streaming content, like streaming audio or video content. In another embodiment, the content device 106 can receive the content on an over the air communication channel.

When the user 102 observes content on the content device 106 and wants to get additional information about a particular piece of content, or wants to purchase a piece of content, the user 102 activates a media device 108. The media device 108 may include an activation mechanism, such as a button, softkeys, voice activation, or other activate technique for receiving an input from the user. The media device 108 may also include a graphical user interface (GUI), such as a screen or display, to interface to the user 102.

In one embodiment, the user 102 enters information about themselves and the content provider 104 that can be used to identify the content provider and the content that the user is interested in. For example, as described further below, the user 102 can enter information about their geographic location such as the city the user 102 is in, information about the content provider 104 that is providing the content such as the local television channel or radio station the user 102 is watching or listening to, and other types of information. This information can be used to identify the content provider, and then based on other information, such as the time the request was made, the particular piece of content that the user is interested in can be determined.

When activated, the media device 108 can forward a request, such as a request for additional information or to purchase the content the user 102 is currently observing to a media server 110. The request can include information that the user entered, as well as other information, such as the user's name, an electronic serial number (ESN) identifying the device, and the like, to the media server 110.

The media device 108 may communicate the request to the media server 110 through any type of electronic communication channel, including wireless, wired, or combination of wireless and wired communication channels. For example, the media device 108 may communicate to the media server 110 using a cellular network, satellite communication networks, paging network, wireless networks based on the Institute of Electronic and Electronics Engineers (IEEE) 802.11 and 802.16 standards, a Bluetooth network, mesh networks, or other wireless networks. The media device 108 may also communicate to the media server 110 via a wired network, such as the Internet. In addition, the media device 108 may communicate to the media server 110 using any combination of wired and wireless communication channels.

In one embodiment, the media server 110 is in communication with a subscriber profile database 112 and can retrieve information about the user 102 when a user sends a request. For example, the subscriber profile data base 112 can include information received from the user when the user setup an account. The subscriber profile data base can include information, such as, the user's city of residence, billing address, information about the user's online account, and other user information. The subscriber profile database can also include information about the users preferences. For example, the subscriber profile database can include information about the types of content that the user has previously download so that suggestions about other similar content can be presented to the user 102 for their consideration.

The media server 110 can also be in communication with a network 114, such as the Internet. The media server 110 can use information received from the media device 108 to search the network for information to identify the content the user is requesting. For example, as described further below, a request sent by a user can identify a time of the request, the geographical location of the user, such as the city the user is in, and the content provider 104 the user is observing, such as the frequency or call letters of a local radio station. The media server 110 can then use this information to search the network 114 for information that identifies the content provider 104 and also the desired content that the content provider 104 was providing when the request was made.

In one example, a request can include a radio station's operating frequency, or call letters, and the city the user is located in. The media server 110 can user this information to identify the radio station broadcasting the content. The media server 110 can then search the Internet for the radio station's website or streaming content from the radio station. Then, based on the time the request was made, or other information, the media server 110 can identify the particular piece of content that the user requested.

Once the media server 110 has identified the content, the media server 110 can search for the desired content. In one embodiment, the media server 110 is in communication with a content database 116. The media server 110 can search the content database 116 and if the desired content is present in the content database 116, the media server 110 can retrieve the desired content and forward it to the user 102. If the desired content is not present in the content database 116, the media server 110 can search for the content in other locations, such as on the network 114. For example, the media server can search for the content on the content provider's website, a third party website, or other network location. Once the media server has located the desired content the media server 110 can retrieve the content and forward it to the user 102. In some cases, the media server 110 may save a copy of the content on the content database 116 for future retrieval.

In the embodiment illustrated in FIG. 1, the functions described for one device can be performed in other devices within the system, and the functions of multiple devices can be combined within a single device. In one embodiment, the functions of the content device 106 and media device 108 can be combined into a single device. For example, a smart phone, or other type of device, can operate as a content device by including an AM or FM radio receiver, or being able to download streaming content and play it on an MP3 player, or the like. The same device can also include a software application that performs the functions of the media device 108. For example, the device can include a software application that identifies information about the content provider that is being observed and when the user indicates that they want additional information, or to purchase, the observed content, the device can send a request to the media server 110.

In one embodiment, information for a request is accumulated and sent over any wired or wireless network to a media serve 110. The media server 110 can interface with various networks, such as the Internet to act as a gateway and facilitate distribution of electronic content. For example, when the media server 110 receives a request it can use the information in the request, such as an Electronic Serial Number (ESN) of the media device 108 to identify the media device 108. The media server 110 can use the identify of the media device 108 to search a subscriber profile database 112 and retrieve a predetermined user profile. In one embodiment, the user profile data is entered when a user subscribes to the service. The user profile can also be updated by the user as the user's profile changes. In addition, the user profile can be updated by the media server 110, for example, a user's preferences or recent downloads can be maintained and updated by the media server 110.

In one embodiment, the user profile includes information that can allow the media server 110 to determine the location of the user. For example, if a user uses a media device 108 that is identified, such as by an ESN, and the user has input information for their profile that they live in San Diego, Calif., then the media server 110 can use this information in searching for content providers. In other words, if a request is received from the user whose profile indicates that they live in San Diego, and the request identifies a content provider as an FM radio station (media field) operating at 91.1 MHz (station field), then the media server 110 can determine that 91.1 MHz in San Diego is FM Radio 91X as the broadcaster that the user is listening to. The media server 110 can then access the Internet, or other network, that may or may not be directly linked to the identified broadcaster and identify the target media from a live stream of the broadcaster, or by recognizing the metatag representing the target media, or other technique. For example, the media server 110 can determine if the request is for a song, or an advertisement, or other content from the broadcaster's live stream on the Internet which may be available directly from the broadcaster of another media web site.

In another embodiment, the request includes information about the user's location. The location information can be entered by the user, or it can be automatically entered, such as from a position location system like a Global Positioning System (GPS) receiver in, or interfaced to, the media device 108. For example, if a user is traveling from San Diego to San Francisco, the user may manually update their location as they move from town to town, or a location device internal to the media device 108 may update their location, or an external location device that is interfaced to the media device can update their location.

In another embodiment, the request can also include a time stamp, or it can be time stamped when received by the media server 110. The time stamp can be used to search for the desired media based, in part, on the time the request was made. In this way, if the broadcaster does not have a live stream, the media server can, for example, examine the broadcasters web site searching for the content that was broadcast at the time of the request, such as searching a play list of a radio broadcaster. In another example, the media server can send a request to the broadcaster asking what content was being broadcast at the time the request was made. In this way, the media server can search for the desired content in a non-realtime mode.

In one embodiment, after the desired content is recognized the media server 110 can search a content database 116 associated with the media server 110. If the desired content is located in the content database 116, then the content is retrieved and forwarded to the user. The desired content can be forwarded to the user by many different techniques, for example, it can be emailed to the user, downloaded or pushed to a user's network enabled device, such as the media device 108, the content device 106, a smart phone, PDA, MP3 player, or other smart device. The content database 116 can include many different types of media content, for example, MP3 files, WAV files WMA files, video files, or other types of content.

In one embodiment, after a transaction has been completed in which the user is to be charged, the transaction can be charged to the user by any number of traditional electronic commerce techniques. For example, a pre-subscribed account the user has setup can be charged, or the user can be charged on a pay per play basis. The transaction can be accounted for and all participating parties in the transaction can be credited accordingly.

There is an up-sell opportunity at the time the user, or consumer, receives the content. For example, if the user receives a song or ring tone to their media device 108, content device 106, or other device and/or email account, the consumer can be presented with the opportunity to buy an entire album, or get additional songs or ring tones that are similar to the one they purchased, etc. In addition, based on the content desired by the user, suggestions for other content that may be of interest to the user can be sent.

Similarly, when an advertisement is heard on radio or seen on television a user can make a request for additional information about the advertisement. The media server 110 can get the additional information about the desired advertisement from the content provider that ran the advertisement, or from the advertiser, or from a third party, or other source of information about the advertised product, goods, or services. For example, the media server 110 can retrieve additional information from the content provider's website or live internet broadcast, from the advertiser's website, from a website affiliated with the advertiser, from a third party website, or from another source of information about the advertisement. In one embodiment, the media server 110 recognizes metatag within the advertisements. The media server 110 can return the requested information to the user, for example, by email, text messaging, messaging to the user's cell phone, or other in other ways. An advertising inquiry transaction can be charged to the user by traditional electronic commerce techniques. In addition, the advertiser can also be charged and credited to the content provider that ran the advertisement

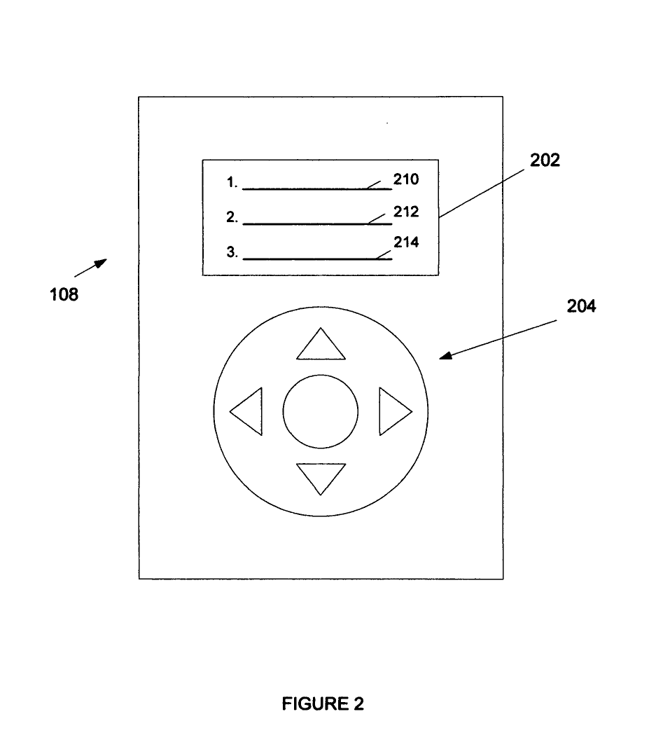

FIG. 2 is a block diagram of an example embodiment of a media device 108 that can gather information to be sent in a media request. In the example shown in FIG. 2, the media device 108 includes a graphical user interface (GUI) 202 and a user data entry area 204, such as a set of keypads, a keyboard, or a control pad. In one embodiment, information for the request is collected into fields, for example, a media field 210, a station, or content provider, field 212, and an optional qualifier field 214. The media field 210 can include information about the type of media content a user is observing, for example, AM radio, FM radio, satellite radio, satellite television, cable television, broadcast television, data from a network such as the Internet, or other type of content provider. The station field 212 can include information about the particular content provider, or station, that the user is observing. For example, the station field 212 can include the frequency of an AM or FM radio station, the call letters of the station, the channel of a television broadcast, the channel number of a satellite radio station, the Uniform Resource Locator (URL) or address of a website, or other information that identifies the station. The qualifier field 214 is an optional field that can include addition information about the user, such as a not to exceed dollar amount for the requested information, or other user information.

In other embodiments, the GUI 202 can include other fields. For example, a field can be included where the user's geographical information can be entered, for example if the user is traveling from San Diego to San Francisco, the user could update their locations as they travel through different cities.

In one embodiment, the fields which make up the request are input by the user 102. For example, the user 102 can use keypads, a keyboard, or control pad in the used data entry area 204 to enter the information into selected fields. In another embodiment, the user data can be imported to the media device 108 from an external device such as a computer through an interface like a USB, or a wireless communication interface such as a Bluetooth interface, or other interface. Alternatively, the user data can be automatically updated. For example, the media device 108 may automatically detect when a user changes a content source they are observing and automatically update the fields of the request.

In another embodiment, the user interface area 204 can include buttons, or keys, that can be pre-programmed. For example, a user can pre-program several buttons to their favorite radio stations. Then when the user changes station on a radio the user is listening to, the station field 212 can be updated by pressing a single pre-programmed button. In other embodiments, buttons can be pre-programmed for other operations, such as updating geographical location, for example, if a user commutes through several towns the user can pre-program keys to be used to update their location information.

The media device 108 can also include other optional features. For example, the media device 108 can include a GPS receiver that can be used to inform a user of their location and the user can update their location information. Alternatively, the GPS receiver can interface to the media device 108 and the user's location can be automatically updated in the request. In addition, functions of a content device 106 can be included in the media device 108. For example, the media device 108 can include an optional AM or FM radio receiver, or other type of content observing device. Likewise, the function of the media device 108 can be included in a content device 106.

In one embodiment where functions of the media device 108 and content device 106 are combined information that is included in a request can be automatically updated. For example, if a user is listening to a radio station and changes to a different radio station, then the station field 212 can be automatically updated with information identifying the new station. Other information in the request can similarly be automatically updated, such as updating the media field 210 when the user changes to a new media source, or updating the users location information from a GPS receiver as the user moves about.

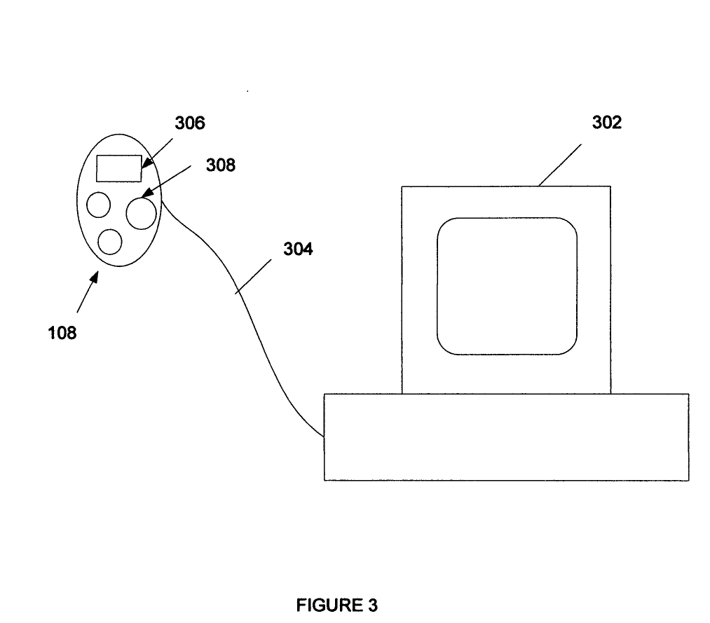

FIG. 3 is a block diagram of another example embodiment of a media device 108 that can gather information to be sent in a media request. In the example shown in FIG. 3, the media device 108 is in a form factor similar to a key bob or other pocket sized device that a user can carry with them. In the example shown in FIG. 3, the fields that make up the request can be entered in an external device, such as a computer 302 and communicated to the media device 108 through an interface, such as a USB interface, Bluetooth interface, or other type of interface, 304. The media device 108 may include an optional user display 306 and user data entry keys, or buttons, 308.

In one embodiment, the user data entry keys 308 can be preprogrammed so that a user can change a field of the request by pressing a single button. For example, the data entry keys 308 can be preprogrammed to a user's favorite radio stations. Then, when the user changes radio stations on a content device, the user can update the station field in the request by pressing a single key or button. In other embodiment, the preprogrammed keys can be used to update other fields in the request. The optional user display 306 can be used to show the user the current values of the fields of the request. In other embodiment, indicator lights, or other types of indications can be used to indicate which of the preprogrammed keys have been pressed.

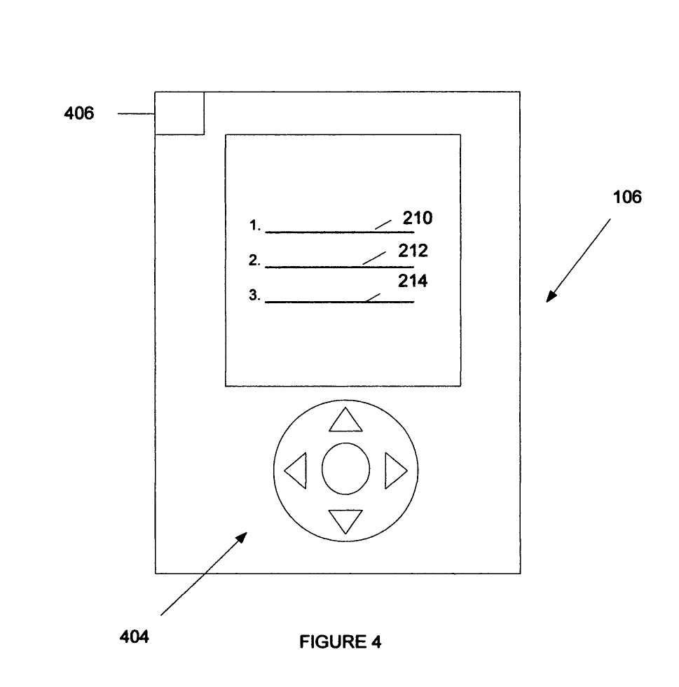

In another embodiment, functions of the media device 108 can be included in a content device 106. FIG. 4 is a block diagram illustrating a content device 106 that includes functions of a media device 108. For example, the content device 106 can be a MP3 player, a smart phone, or other network enabled device. In one embodiment, in a manner similar to those described for FIGS. 2 and 3, a user enters data into the fields of a request. As the user listens to the content device 106, the user can use a keypad, or other user interface 404 to operate the content device 106 in its normal manner. When the user hears or sees content that they want, such as a song they want to purchase, the user can press a button, or otherwise active the operation of media device functions that sends a request to the media server 110.

In another embodiment, the fields of the request can be updated automatically as the user operates the content device 106. For example, if the user changes radio station they are listening to the station field of the request can automatically be updated. In addition, if the content device 106 includes, for example, a GPS receiver, or other location device, 406, the user's location can be automatically updated and communicated to the media server 110 when a request is made.

As described in FIGS. 2-4, the media device 108 can be either an independent wireless device designed to work with the media server 110, or a software application that is designed to be downloaded or installed on any existing wireless device, such as a smart phone, a PDA, a Cell Phone, a MP3 player, or any other type of content device. In one embodiment, the hardware device and a wireless application protocol (WAP) perform the operations and functions described herein that are associated with the content device 106 and the media device 108.

In one embodiment, once the media, station, and quantifier (when necessary) fields are determined, then a request can be communicated from the media device 108 to the media server 110. For example, a request can be made when a song, advertisement, or promotion is heard that the user wishes to get additional information about, or interact with, such as purchasing music, or video, getting additional information about a product that was advertised, participating in a poll, or a game show, or other type of information. In one example, the user can be observing content, such as watching television, and when a commercial for a product that the user is interested in is shown the user can request additional information about the product. In still another example, a user can be watching a television show, such as a cooking show, and when the television chief prepares a dish that the user is interested in, a request for the recipe can be sent. In yet another example, a user can be watching a television show or pay per view movie, and when the user sees something that want additional information about a request can be sent for the information. For example, if the user is watching a pay per view movie, and in the movie there is a car race scene, the user can, for example, use the optional field 214 of the request to request additional information about a car in the scene.

Table 1, below illustrates example embodiments of entries in fields of a request. In the example of Table 1, there are three fields. The first field, listed in the first column of Table 1, is a media field that identifies the type of media that the user is observing. For example, the media field can include values representing AM radio, FM radio, satellite radio, broadcast television, cable television, satellite television, the Internet, and the like.

The second field, listed in the second column of Table 1, is a station field that identifies a station, or station identifier of the content provider of the media. For example, if the media field indicates that the user is listening to AM radio the station field can include a value between 530 and 1710 corresponding to the operating frequency of AM radio broadcast stations. In another example, if the media field indicates that the user is observing cable television, then the station field can include values corresponding to the stations available from the cable service provider. Likewise, if the media field indicates that the user is observing content from the Internet, the station field can include the universal resource locator (URL) or address of the website the user in observing. Other examples of the media and station fields are included in Table 1.

An optional third field, listed in the third column of Table 1, is a qualifier column. The qualifier field can include additional information to further identify the content being observed by the user. For example, the qualifier field can include information about the action that the user wants to take, such as to buy a song, buy an album, preferences of the user, limits on the amount the user wants to spend, and other information. The qualifier field can also include information about the user's location, the time of the request, and other information.

TABLE 1

| Media Field | Station Field | Qualifier Field |
|---|---|---|
| AM Radio | 530-1710 | Buy/More Info/Spending |
| | | Limit/Location/etc. |
| FM Radio | 87.5-108.0 | Buy/More Info/Spending |
| | | Limit/Location/etc. |
| Satellite | XM/Sirius | Buy/More Info/Spending |
| Radio | | Limit/Location/Contest Entry/ |
| | | etc. |
| Broadcast | ABC/CBS/NBC/FOX/etc. | Buy/More Info/Spending |
| Television | | Limit/Location/Contest Entry/ |
| | | etc. |
| Cable | ESPN/CNN/HBO/etc. | Buy/More Info/Spending |
| Television | | Limit/Location/Contest Entry/ |
| | | etc. |
| Satellite | ABC/CBS/NBC/FOX/etc. | Buy/More Info/Spending |
| Television | | Limit/Location/Contest Entry/ |
| | | etc. |
| Internet | URL/Company Name/etc. | Buy/Download/More Info/ |
| | | Spending Limit |

In one embodiment, a user can use the system to purchase music. In other embodiments, the system can also acts as an interactive gateway to give users access to requested information on radio and television advertisements and to participate in game shows and fund raisers from any media including AM/FM Radio, Satellite Radio, Satellite Television, Cable Television, Network Television and the Internet.

In another embodiment, as content, such as a song is broadcast by a content provider there is data included in the broadcast. For example, many radios now include information such as the song title and artist and the identity of the broadcaster so that this information can be displayed to the user as the song is being played. In one embodiment, this additional data can be included in a request that is sent to the media server 110.

In another embodiment, a technique referred to as interactive advertising radio can be implemented. Interactive advertising radio can be used by national advertisers to narrow their advertisements to target specific geographic areas and target markets. In other embodiments, national advertisers can use interactive advertising on other types of media, such as, television, the Internet, and such.

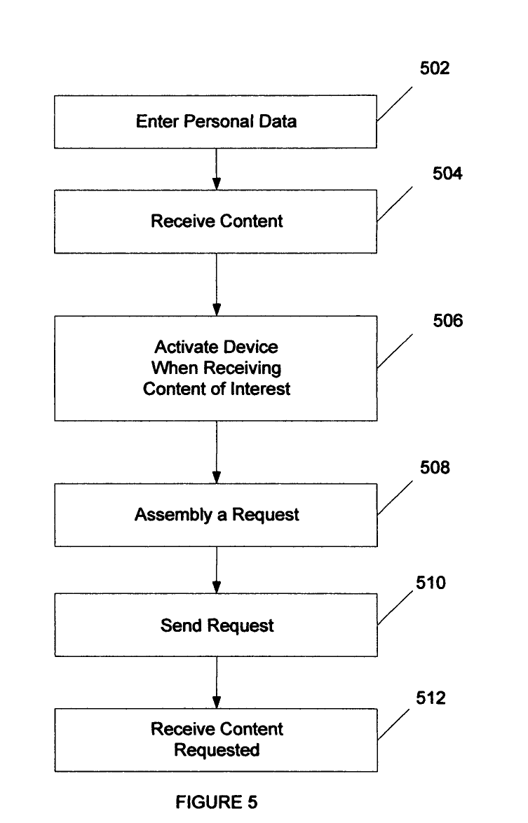

FIG. 5 is a flow chart illustrating an example embodiment of requesting content. Flow begins in block 502 where a user enters personal information that can be included in a request into a media device, such as the media device 108 illustrated in the examples of FIGS. 1-3. The personal information can be entered by the user into the media device by keys, a keyboard, or a control pad, that is part of the device, or via an external device that is in communication with the device, or transferred from a memory stick, or the like. The information can include the user's location, as well as the source of the content that the user is observing. Flow continues to block 504 where the user receives and observes selected content. The user can receive and observe the selected content on a content device, such as the content device 106 illustrated the examples of FIG. 1-3. In other embodiments, the content device and the media device can be the same device such as illustrated in the example of FIG. 4.

Flow continues to block 506. In block 506 when the user observers content that they are interested in, and want to purchase the content or get more information about the content, or other information, the user activates the media device. Flow continues to block 508 where, when the user activates the media device, a request for the identified content is assembled. The request can include information that is used to identify the content that is being observed. For example, the request can include information about the content provider that the user is observing as well as the time that the request was made. In another embodiment, a time stamp can be associated with the request when the request is received at a media server. The request can also include information about the user, such as the user's location.

Flow continues to block 510. In block 510, the request is sent to a media server, such as the media server illustrated in FIG. 1. The request can be sent wirelessly or through a wired connection or through a combination of wireless and wired connections. For example, the request can be sent via a cellular network, a paging network, a network based on the Worldwide Interoperability for Microwave Access (WiMAX) standards (i.e., the Institute for Electrical and Electronics Engineers (IEEE) 802.16 Working Group on Broadband Wireless Access Standards), a network based on the Wireless Fidelity (WiFi) standards (i.e., the Institute for Electrical and Electronics Engineers (IEEE) 802.11 Working Group for Wireless Local Area Networks Standards), a Ethernet network, the Internet, or other communication network. Flow continues to block 512. In block 512, the user receives the requested content. For example, the requested content can be received by the user's media device, or content device, or it can be emailed to the user, or otherwise communicated to the user.

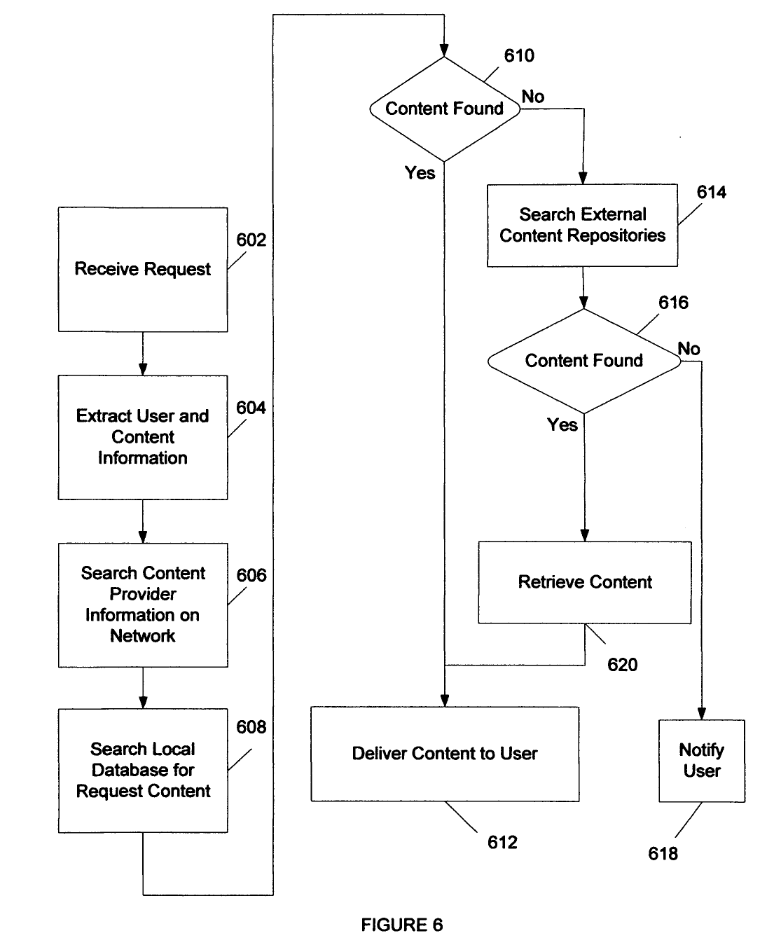

FIG. 6 is a flow chart illustrating an example embodiment of receiving a request for content and delivering the content to a user. Flow begins in block 602. In block 602 a request for content desired by a user is received at a media server. Flow continues to block 604. In block 604, information about the user and the content are extracted from the request. In one embodiment the request includes information that is used to identify the desired content. For example, the request can include information identifying the source of the content, the time the request was made, as well as the location of the user requesting the content. The request can also include other information, such as instructions about what the user wants, such as to purchase the content, get additional information about the content, spending limits, etc. In addition, the request can include information that can be used to search a user profile database to get additional information about the user. In one embodiment, the type of content identified can be used to automatically determine the type of actions taken. For example, if the content identified is an advertisement, then it may be automatically determined that the user wants additional information about the item being advertised.

Flow continues to block 606, where the server uses information received in the request to search for information about the content provider. In one embodiment, the server searches a network, such as the Internet, to get information from the content source. For example, the server can search the Internet to find a content stream provided by the content source. The server can then examine the stream to identify the requested content. In another embodiment, the server searches a network, such as the Internet, for the content provider's website. The server can then search the website to identify the requested content. For example, the time the request was made can be used to search the content provider's website to identify what content was being provided at the time the request was made. In another embodiment, the server can send a request to the content provider for the identity of the content that the content provider was providing when the request was made.

Flow continues to block 608 where the server uses the identity of the content desired by the user to locate the content. In one embodiment, a database in communication with the server can be searched to determine if the requested content is available from the database. Flow continues to block 610. In block 610 if it is determined that the requested content is available from the database flow continues to block 612 and the content is provided to the user.

Returning to block 610, if it is determined that the requested content is not available in the database, flow continues to block 614. In block 614 the server searches other content repositories, such as other databases on the network, such as the Internet, to locate, and retrieve the requested content. In another embodiment, the server searches for a streaming feed from the content provider that includes the desired content and identifies or retrieves the desired content from the streaming data. Flow then continues to block 616. In block 616, if the requested content is not located flow continues to block 618 and the user is notified that the requested content could not be found. Returning to block 616, if the requested content is found, flow continues to block 620 and the requested content is retrieved. For example, the server can purchase content, such as a song or video, from a content provider website or a third party website. In another example, if the request was for additional information about an advertisement, the server can get information from the advertisers website or a third party website. Flow then continues to block 612 and the content is delivered to the user.

The desired content can be delivered in many different ways. For example, the content can be emailed to the user, or the content can be sent via any wired or wireless communication channel to the user. For example, the content can be pushed to the user's content device, or the user can download the content.

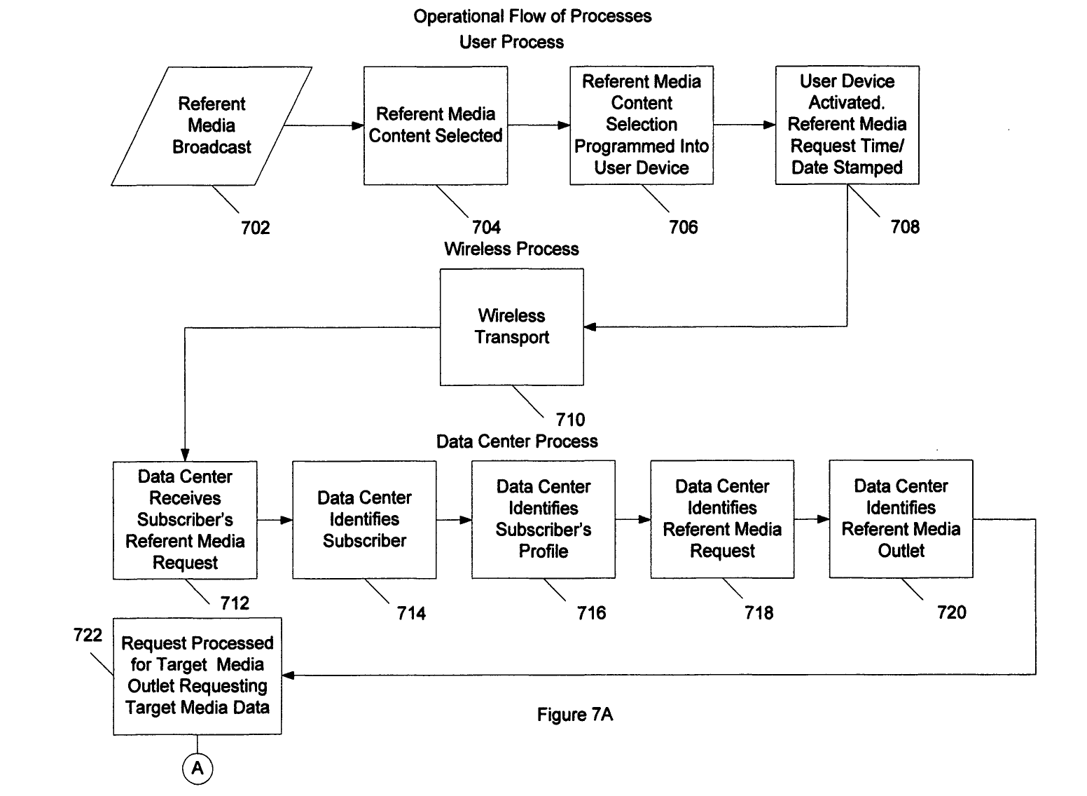

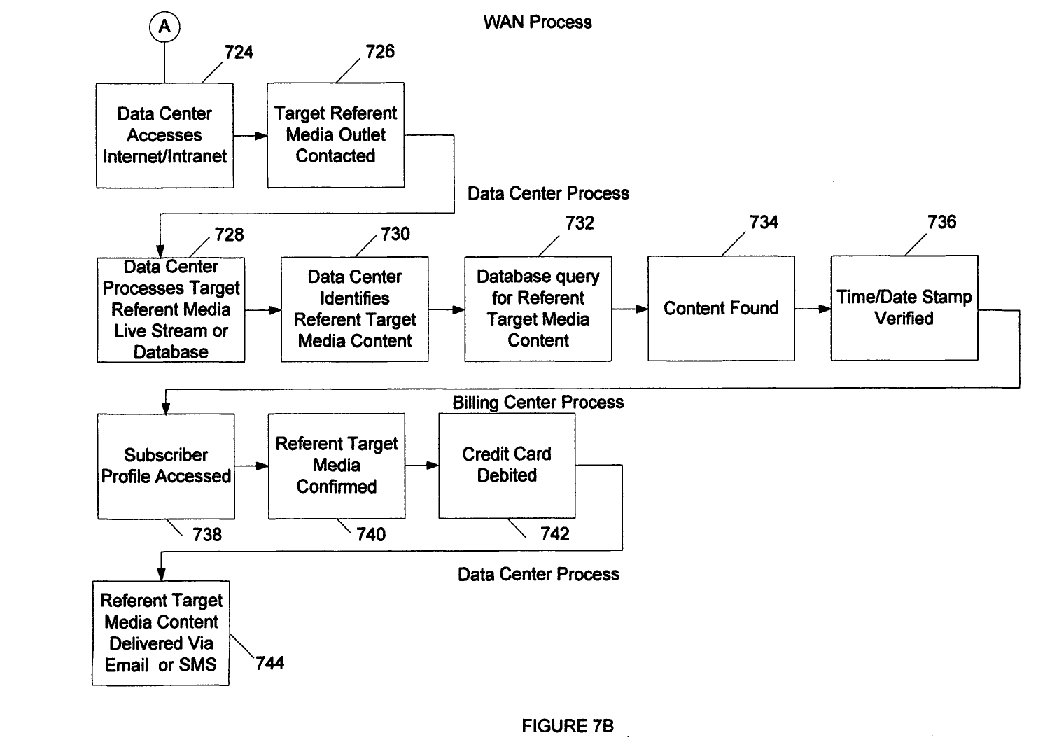

FIGS. 7A and 7B are a flow diagram illustrating an example embodiment of an integrated media electronic distribution and commerce system. As shown in FIG. 7A, flow begins in a referent media broadcast block 702 where a user observes media content from any electronic media outlet, such as broadcast terrestrial radio, satellite radio, satellite television, cable television, broadcast television etc. Flow then continues to a referent media content selection block 704 where a user identifies referent media content to be observed. Then in a referent media content selection block 706 a user sets fields identifying parameters of the referent media content. Flow continues to block 708 where a user media device is activated. A referent media request that is time/date stamped is generated. This is referred to as “the request.”

Flow continues to block 710 where a wireless device module uses any wireless connection methodology to connect to a data center server. In another embodiment, the devise module uses a wired connection. Flow continues to block 712. In block 712 a data center receives the subscriber's referent media request. Flow continues to block 714 where a data center identifies the subscriber, for example, using an identification (ESN) number from a standard paging network or cellular service provider, or using a wireless application protocol (WAP) application on subscriber's mobile device. Flow continues to block 716 and a data center module identifies the subscriber's profile, for example, by making a query to a subscriber database which returns the current subscriber profile. Flow continues to block 718 and in a data center referent media request module the current referent media content is identified. Flow continues to block 720 where a data center module identifies the referent media outlet which identifies the referent media outlet that is queued for WAN process. Flow continues to block 722 where a request process module processes the target media outlet, requests the target media, and sends a request to a WAN Process to access target media outlet.

Flow continues in FIG. 7B, to block 724 where a data center accesses Internet/intranet module accesses the Internet/intranet to find the target media or “live media stream.” Flow continues to block 726 where a target referent media outlet module establishes a connection between the data center and the target media, such as the target media live stream, either on the media outlet's, public websites or through a direct link.

Flow then continues block 728 where a data center process target referent media module examines a live stream or database and the data center server detects the time coded target media Flow continues to block 730 in a data center identify referent target media content module where the target media identity is deciphered and recognized. Flow continues to block 732 in a database query referent target media content module where the recognized target media is requested from the data center's database and/or the actual target media from the information is displayed or presented by the media outlet connection. Flow continues to block 734 where, in a content found module, the referent target media content is found. Flow continues to block 736 where in a time/date stamp verified module, the time/date stamp is verified.

Flow continues to a Billing Center Process. In block 738, a subscriber profile access module accesses a billing profile from the subscriber profile. Flow continues to block 740 where in a referent target media content confirmed module the content is confirmed. Flow then continues to block 742 where, in a credit card debit module, billing occurs, for example, to a subscriber credit card. Flow continues to a data center process where in block 744 a referent target media content module delivers the retrieved content to the user. The content can be deliver in many different ways, for example, via email, or SMS, or other form of electronic communication.

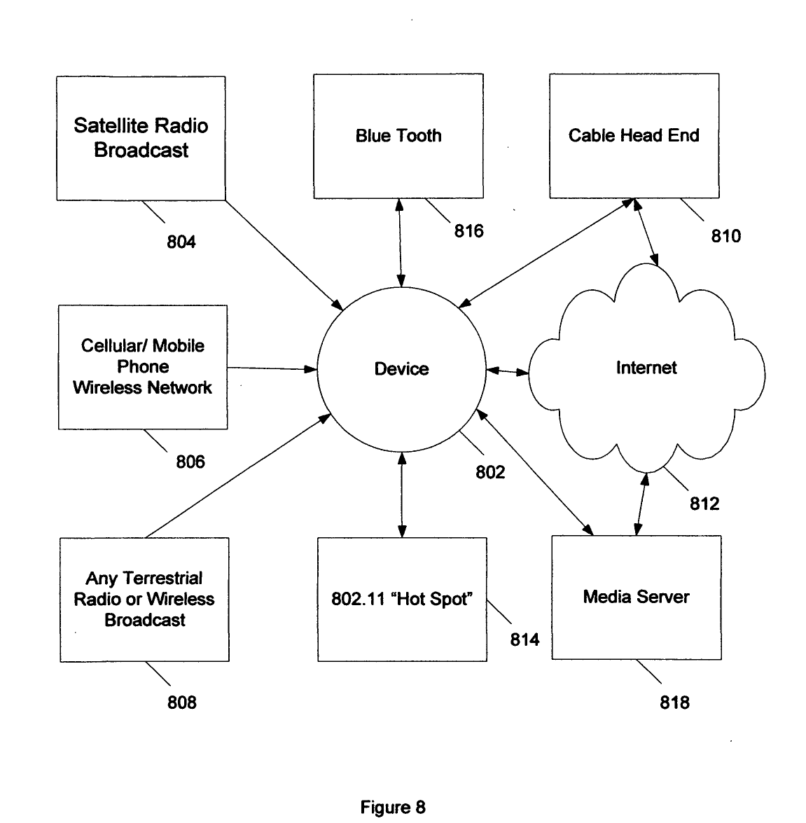

FIG. 8 is a block diagram of another example embodiment of an interactive content distribution system. In the example of FIG. 8, a user device 802 receives content from a content provider. For example, the content can be broadcast from a satellite, such as broadcast radio systems 804 like Sirius or XM radio. The content can also be broadcast by cellular telephone, or other wireless networks 806 or other terrestrial networks 808, such as broadcast television, or broadcast radio or WiMAX networks. In addition, terrestrial networks can include cable networks 810, and other networks, such as the Internet 812. The device 802 can also receive content from wireless networks, such as WiFi hot spots 814, or Bluetooth wireless networks 816.

The user device 802 receives content that is observed by a user. The user can then use the user device 802 to send information to a media server 818. The media server 818 receives the request and uses information in the request to identify the requested content. The identified content is then retrieved and provided to the user device. In one embodiment, the information is sent directly to the media server 818. In other embodiments the information can be communicated to the media server 818 via any wired or wireless network.

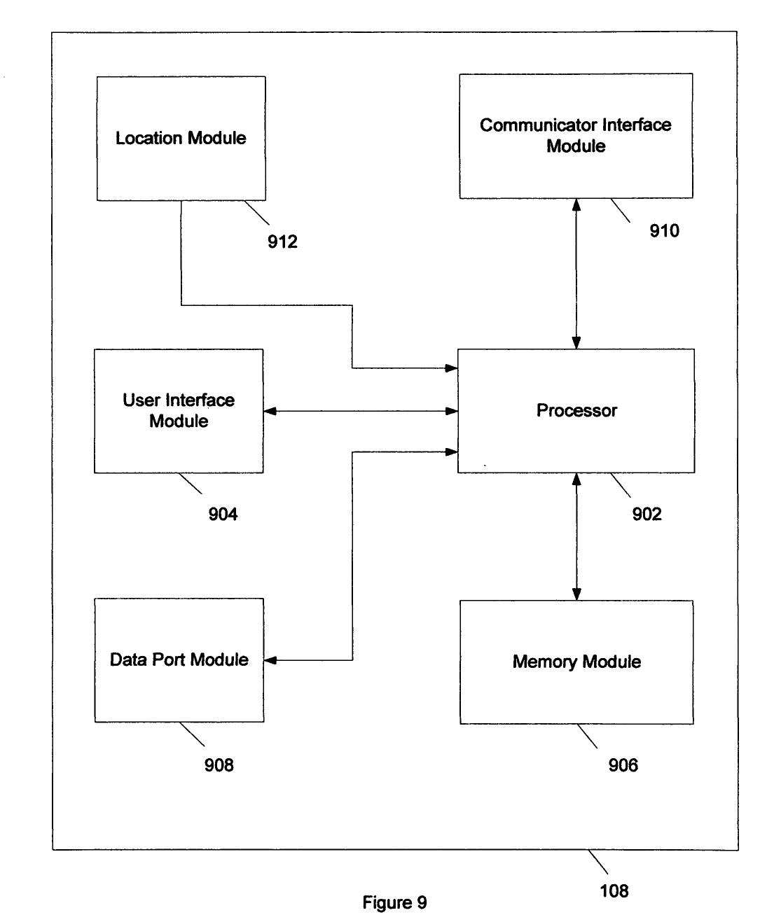

FIG. 9 is a block diagram of an example embodiment of a media device 108. As shown in the example of FIG. 9, the media device 108 includes a processor 902. The processor is in communication with a user interface module 904. The user interface module 904 can include a user input, such as keypads a keyboard, or a control pad, or other type of user input device so that a user can enter information into the media device. The user interface module 904 can also include a display, or indicator lights, so that information can be presented to the user. In one embodiment, the user can enter information about content that the user is observing. For example, the user can enter information indicating the type of content they are observing, such as AM or FM radio or broadcast or cable television, etc., as well as information indicating the particular station, such as the radio frequency or call letters of a radio station or a television channel. In one embodiment, the user's entries can be displayed to the user on the display so that the user can verify their accuracy. The user interface module 904 can also include speakers so that audio information can be provided to the user. Information received from the user can be stored in a memory module 906.

The media device 108 can also include a data port module 908 that can receive and transmit data with an external device. For example, the data port module 908 can receive information about the content from an external device, such as a content device. The data port module 908 can also receive information, such as information about the user from an external device, such as a computer. The data port module 908 can also output data to an external device, such as output data to a content device or a computer.

The processor 902 is also in communication with a communication interface module 910. The communication interface module 910 can transmit and receive data to an external network. In one embodiment, the communication interface module 910 transmits and receives data with a wireless network, such as a cellular network, a WiMAX network, a WiFi net work, a Bluetooth network, or other type of wireless network. In another embodiment, the communication interface module 910 transmits and receives data with a wired network, such as the Internet.

In one embodiment, a user enters information identifying a source of the content that they are observing which is stored in the memory module 906. When the user observes content that they are interested in, for example, the user is listening to a radio station and hears a song they would like to purchase, the user activates the media device 108. The user can activate the media device 108 by pressing a button or key in the user interface module or otherwise activate the device. The processor 902 detects that the user has activated the media device 108 and retrieves the information identifying the source of the content from the memory module 906. The processor 902 communicates a request for the desired content that includes the retrieved information, along with any other desired information, such as the time of day, location, or other information, to the communication interface module 910. The communication interface module 910 communicates the request to an external media server by a wired or wireless communication channel. The media server can use the information in the request to identify the requested content.

In one embodiment, the media server transmits the requested content to the communication interface module 910 in the media device 108. The processor 902 can then save the requested content to the memory module 906. The requested content can then be provided to the user via the user interface module 904. For example, the requested content can be provided to the user via the display or speakers in the user interface module 904. In another embodiment, the requested content can be communicated to the user over a different communication channel, such as, email to the user or downloaded or pushed to another user device.

In another embodiment, the media device 108 can perform the functions of a content device. For example, the communication interface module 910 can include an AM/FM radio receiver. Likewise the communication interface module 910 can receive streaming content from the Internet and present the content to a user.

In still another example, the media device 108 may include a location module 912. The location module may provide information to the processor 902 about the geographical location of the media device 108. In one example, the location module 912 includes a GPS receiver, or other type of location device. In another example, the location module 912 interfaces to an external local device, such as an external GPS receiver.

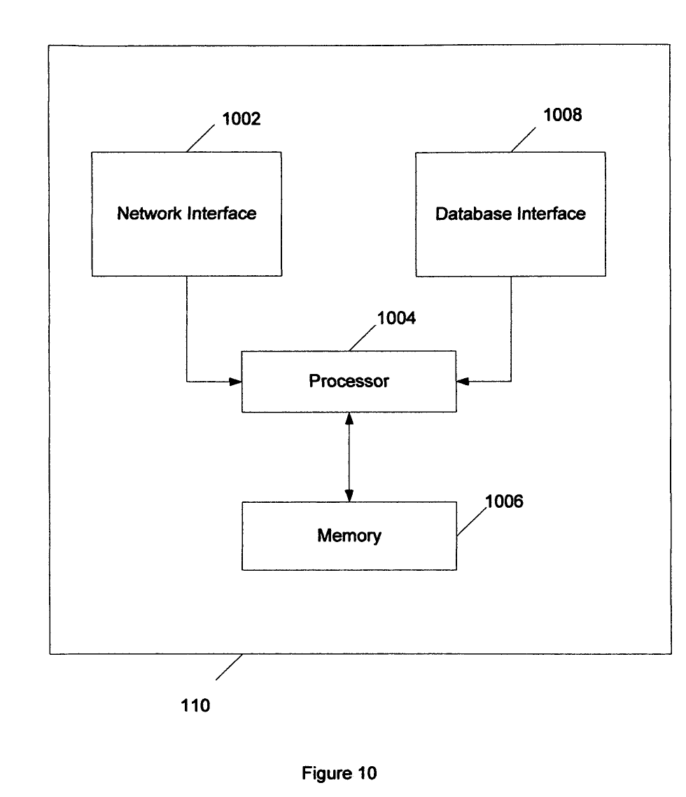

FIG. 10 is a block diagram of an example embodiment of a media server 110. As shown in the example of FIG. 10, the media server 110 includes a network interface module 1002. The network interface module 1002 can receive a request for desired content from a requesting user. The network interface module 1002 can interface to a wired or wireless network. For example, the network interface module 1002 can interface to a cellular network, a paging network, a WiMAX network, a WiFi network, the Internet, a wide area network, or other type of network. In addition, the network interface module 1002 may interface to multiple networks, such as a wireless network and the Internet simultaneously. The network interface module 102 communicates the request to a processor 1004.

The processor 1004 receives the request and examines it and extracts information identifying the content provider and determines a time the request was made. The processor 1004 can initiate a search of a network for the content provider. For example, based on the information identifying the content provider the processor 1004 may initiate a search of the Internet via the network interface 1002. Upon locating the content provider, the processor 1004 identifies the content that the content provider was providing when the request was made based on, for example, the time the request was made. The processor 1004 then retrieves the desired content and provides the desired content to the network interface module 1002 that transmits the desired content to the requesting user.

The media server can also include a memory module 1006 that can store the desired content until it can be delivered to the requesting user. In addition, the memory module 1006 can be used by the processor 1004 for temporary storage during operation of the media server 110. The media server may also include a database interface module 1008. The database interface module 1008 can interface to a subscriber profile database, a content data base, or other local data bases. For example, the database interface module 1008 can access, store, and retrieve information about a user, or subscriber, that can be used during operation of the media server 110. The database interface module 1008 can also access, store, and retrieve content. In this way, the content database can be used to maintain local copies of previous content that has been retrieved so that when content that has been previously retrieved is requested, the media server 110 can retrieve the content from the content database and not have to search the network for the content.

Various embodiments may be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The term “module” as used herein means, but is not limited to a software or hardware component, such as an FPGA or an ASIC, which performs certain tasks. A module may advantageously be configured to reside on an addressable storage medium and configured to execute on one or more network enabled devices or processors. Thus, a module may include, by way of example, components, processes, functions, attributes, procedures, subroutines, segments of program code, drivers, firmware, microcode, circuitry, data, databases, data structures, tables, arrays, variables, and the like. The functionality provided for in the components and modules may be combined into fewer components and modules or further separated into additional components and modules. Additionally, the components and modules may advantageously be implemented to execute on one or more network enabled devices or computers.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

While the above is a complete description of the preferred embodiment of the present invention, it is possible to use various alternatives, modifications and equivalents. Thus, the invention is not intended to be limited to the embodiment shown herein but is to be accorded the widest scope consistent with the principal and novel features disclosed herein.

1. A method of distributing content, the method comprising:
receiving content from a content provider;
activating a media device when desired content is observed;
assembling a request for the desired content, the request including information identifying the content provider;
communicating the request for the desired content to a media server that extracts the information identifying the content provider, the media server searches a network for the content provider and identifies the content that the content provider was providing when the request was made;
retrieving the desired content; and
providing the desired content to a requesting user.

2. The method of claim 1, wherein searching a network for the content provider comprises searching the Internet for the content provider's website.

3. The method of claim 1, further comprising identifying the content that the content provider was providing based on a time the request was made.

4. The method of claim 1, wherein communicating the request comprises communicating over a wireless communication channel.

5. The method of claim 1, wherein providing the desired content to the requesting user comprises emailing the desired content to the requesting user.

6. The method of claim 1, wherein providing the desired content to the requesting user comprises downloading the desired content to the requesting user.

7. The method of claim 1, wherein the desired content comprises an audio file.

8. The method of claim 1, wherein the desired content comprises a video file.

9. The method of claim 1, wherein the desired content comprises an advertisement.

10. The method of claim 1, wherein retrieving the desired content comprises retrieving the desired content from the content provider's website.

11. The method of claim 1, wherein retrieving the desired content comprises retrieving the desired content from a third party website.

12. A method of requesting content, the method comprising:
observing content provided by a content provider;
providing an indication that currently observed content is desired content;
providing a request for the desired content, the request comprising information identifying the content provider;
communicating the request for the desired content to a media server.

13. The method of claim 12, further comprising receiving the desired content from the media server.

14. The method of claim 12, wherein the request further comprises a geographic location.

15. The method of claim 12, wherein the request further comprises a time the request was made

16. A method of distributing content, the method comprising:
receiving a request for desired content from a requesting user, the request comprises information identifying a content provider,
extracting the information identifying the content provider;
searching a network for the content provider and based on information;
identifying the content that the content provider was providing when the request was made;
retrieving the desired content; and
providing the desired content to the requesting user.

17. The method of claim 16, wherein the request further comprises a time the request was made.

18. The method of claim 16, wherein providing the desired content to the requesting user comprises emailing the desired content to the requesting user.

19. The method of claim 16, wherein the request further comprises a geographic location.

20. The method of claim 16, wherein searching a network for the content provider comprises searching the Internet for a content provider's website.

21. The method of claim 16, wherein searching a network for the content provider comprises searching the Internet for a content provider's streaming media.

22. The method of claim 16, wherein retrieving the desired content comprises retrieving the desired content from the content provider's website.

23. The method of claim 18, wherein retrieving the desired content comprises retrieving the desired content from a third party website.

24. A media device comprising:
a user interface for entering an indication that currently observed content is desired content;
a processor that receives the indication and assembles a request for the desired content, the request including information identifying the content provider; and
a communication interface that receives the request from the processor and transmits the request for the desired content to a media server.

25. A media server comprising:
a network interface that receives a request for desired content from a requesting user, the request comprises information identifying a content provider, and
a processor that examines the received request and extracts the information identifying the content provider, the processor initiating a search of a network for the content provider and based on the information, identifies the content that the content provider was providing when the request was made, the processor retrieves the desired content and provides the desired content to the network interface that transmits the desired content to the requesting user.
